(19) United States
(12) Patent Application Publication
(10) Pub. No.: US 2015/0215240 A1
(43) Pub. Date: Jul. 30, 2015

(54) MESSAGING SYSTEM

(71) Applicant: MGM Resorts International, Las Vegas, NV (US)

(72) Inventors: Rajeshwar Salvaji, Henderson, NV (US); Mudit Chandra, Henderson, NV (US)

(73) Assignee: MGM Resorts International, Las Vegas, NV (US)

(21) Appl. No.: 14/167,224

(22) Filed: Jan. 29, 2014

(51) Int. Cl. H04L 12/58

(52) U.S. Cl. CPC H04L 51/00

(57) ABSTRACT

Communication is provided between a plurality of different service industry systems which communicate in incompatible formats. A message intended for a destination system and in a format used by the origin system may be received from a first system. The received message may be converted into an intermediary format. The intermediary format may be in the form of an extended markup language (XML) file or other document type. A specification associated with the origin system may be used to map data fields from the received message to the intermediary XML document. A specification document associated with the destination system may be used to translate the intermediary document to an outgoing message that conforms to a format used by the destination system. The outgoing message may then be used transmitted to the destination system.

### BACKGROUND

The service industry is a multi-billion dollar industry and includes businesses such as casinos. Casinos offer their guests room accommodations, restaurants, spas, gambling, entertainment events, and other services. In some cities, multiple casinos are located relatively next to each other. Guests visiting these areas often visit more than one casino.

A guest staying at one casino sometimes wishes to partake in a service offered from another casino. For example, a guest staying at one casino may wish to eat at a restaurant in another casino, go to a concert or spa at another casino, or partake in some other event. Because most casinos and other service industry companies have their own infrastructures and operate as several businesses, it can be inconvenient to make reservations and payment for services rendered between service industry companies.

What is needed is an improved system for conducting business between multiple service industry companies

### SUMMARY

The present technology allows communication between a plurality of different service industry systems. A message intended for a destination system may be received from a first system. The message may be in a format used by the origin system but incompatible with the destination system. The present technology may convert the received message to an intermediary format. The intermediary format may be in the form of an extended markup language (XML) file or other document type. A specification associated with the origin system may be used to map data fields from the received message to the intermediary XML document. A specification document associated with the destination system may be used to translate the intermediary document to an outgoing message that conforms to a format used by the destination system. The outgoing message may then be used transmitted to the destination system. The origin system and destination system may be any system, such as for example casino room management system, facility reservation system, a credit card processing system, or other system, that communicates messages and has a format to the messages it transmits and receives.

In an embodiment, a method for processing a message intended for a destination may receive a first message by an application from a first system of a plurality of systems and intended for a second system. The message may have a first format associated with the first system. The first message may be converted into a file having a second format. A second message may be generated having a third format associated with the second system from the file. The second message may be transmitted to the second system.

In embodiments, the method described above may be performed by systems including application servers and data stores. Additionally, one or more modules stored on memory may be executable by one or more processors to perform the methods and functionality described herein.

### BRIEF DESCRIPTION OF THE DRAWINGS

FIG. 1 illustrates a system for converting messages sent between incompatible systems.

FIG. 2 illustrates a method for processing messages.

FIG. 3 illustrates a method for processing a message request.

FIG. 4 illustrates a method for converting a message to a destination format.

FIG. 5 illustrates a method for processing an settlement request.

FIG. 6 illustrates a method for processing a batch of settlements.

FIG. 7 illustrates a computing environment for implementing the present technology.

### DETAILED DESCRIPTION

The present technology allows communication between a plurality of different service industry systems. A message intended for a destination system may be received from a first system. The message may be in a format used by the origin system. The present technology may convert the received message to an intermediary format. The intermediary format may be in the form of an extended markup language (XML) file or other document type. A specification associated with the origin system may be used to map data fields from the received message to the intermediary XML document. A specification document associated with the destination system may be used to translate the intermediary document to an outgoing message that conforms to a format used by the destination system. The outgoing message may then be transmitted to the destination system.

The origin system and destination system may be any system, such as for a example casino room management system, facility reservation system, a credit card processing system, or other system, that communicates messages and has a format to the messages it transmits and receives. For example, an origin system and/or destination system may be implemented as InfoGenesis, Aloha, Micros 9700, Micros 9200, OPERA, LMS, and other types of systems.

Though the present technology may be discussed herein with respect to service industry systems such as reservation systems, credit card systems, and other casino related systems, the present technology may be used with respect to other systems as well.

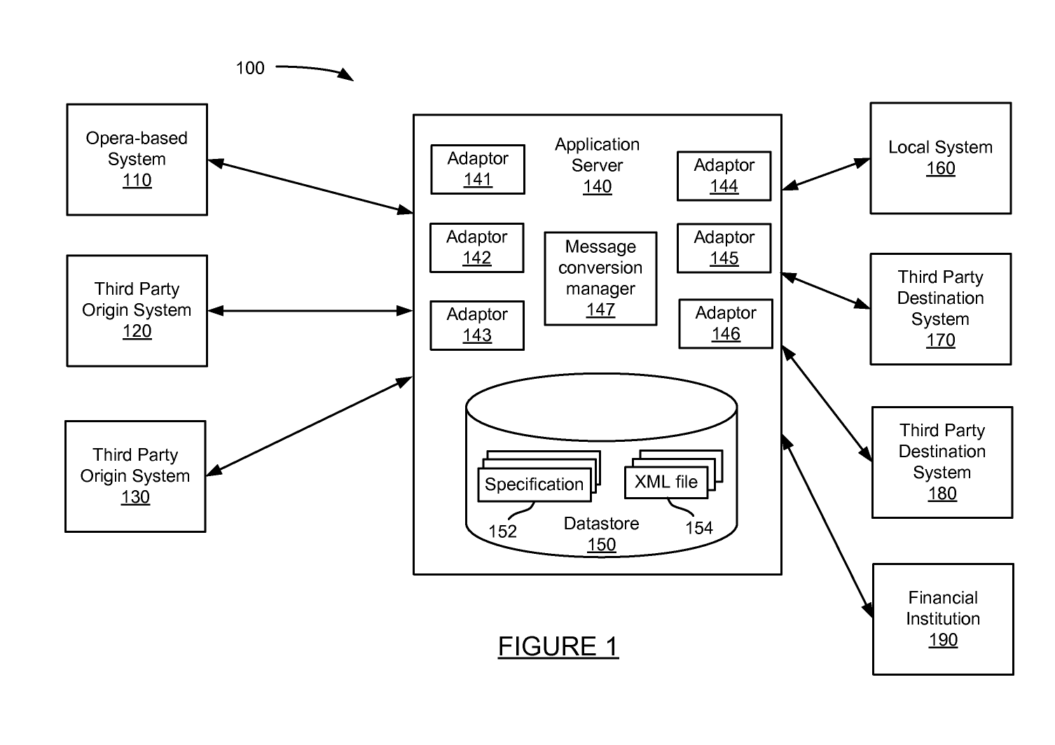

FIG. 1 illustrates a system for converting messages sent between incompatible systems. System 100 of FIG. 1 includes OPERA-based system 110, third party origin system 120, third party origin system 130, application server 140, local system 160, third party destination system 170, third party destination system 180, and financial institution 190.

Each of systems 110-130, server 140 and systems 160-190 may communicate over one or more networks. The networks may be any network suitable to facilitate communication of data between different servers, devices and machines. The one or more networks may be implemented as a private network, public network, intranet, the Internet, a cellular network, Wi-Fi network, VoIP network, or a combination of one or more of these networks.

OPERA based system 110 may include one or more systems for communicating reservations with application server 140. For example, the system 110 may be implemented by an external business that sends reservation requests with credit card numbers to application server 140 and intended for one of systems 160-180.

Third party origin system 120 may also communicate information such as credit card numbers, restaurant reservation requests, event reservation requests, and other requests to application server 140 and intended for one of systems 160-180. For example, when application server 140 is implemented by a casino, the third party remote system 120 may be implemented by a partner such as a restaurant, event ticketing service, or other service which may transmit sensitive information to the casino. Application server 140 may receive the message, process the message, and either transmit the message to a local system 160 or third party destination system 170-180. Communications from system 120 may include requests and/or messages in a format that is not compatible with other systems such as systems 160-180.

Third party origin system 130 may also communicate information to application server 140 and may be associated with the same or different service as system 120. Communications from system 130 may include requests and/or messages in a format not compatible with systems 160-180.

Application server 140 may communicate with systems 110-130 and systems 160-190. Application server 140 may also communicate with other machines and devices (not illustrated in FIG. 1). Application server 140 may include incoming message adaptors 141-143, outgoing message adaptors 144-146, message conversion manager 147, and datastore 150. Though only one application is illustrated on application server 140, application server 140 may host one or more applications, one or more portions of a distributed application and other software modules that may be executed to perform the functionality discussed herein.

Data store 150 may be implemented locally to remote from application server 140. Data store 150 may include specifications 152 and XML files 154. Each specification 152 may include information for converting a type of message to and/or from the intermediary XML format. For example, a first specification may include field mapping information between an Opera formatted message and the intermediary XML file while another specification document may include field mapping information between an intermediary XML file and a Micros 9700 formatted message.

Adaptors 141-143 may process messages received from systems 110-130. When received, a message may be stored in memory at application server 140. The queued messages may eventually be accessed by one of adaptor 141-143 and converted into an intermediary XML format.

Message conversion manager 147 may detect when received messages are stored, place them in a queue, and feed them to an adaptor when as soon as an adaptor is available. When XML files are generated, message conversion manager 147 may provide the XML file to an available adaptor.

Adaptors 144-146 may receive an XML file generated from a received message, determine the intended destination of the received message, and generate an outgoing message in the format of the receiving system. In some instances, message conversion manager 147 may provide XML files to one of adaptors 144-146 when an adaptor becomes available.

Application server 140 may receive settlement requests and authorization requests from systems 110-130 and may periodically send a batch of the settlements to financial institution 190. The batch settlements may be sent using FTP protocol or some other protocol to financial institution 190. In some embodiments, the batch of settlements may be sent daily, monthly, or based on some other event.

Financial institution 190 may include one or more banks or other institutions that may send and receive information over a network with application server 140. For example, financial institution 190 may be implemented by a bank that processes batch settlements, provides authorizations for credit cards and debit cards, and provide other financial services.

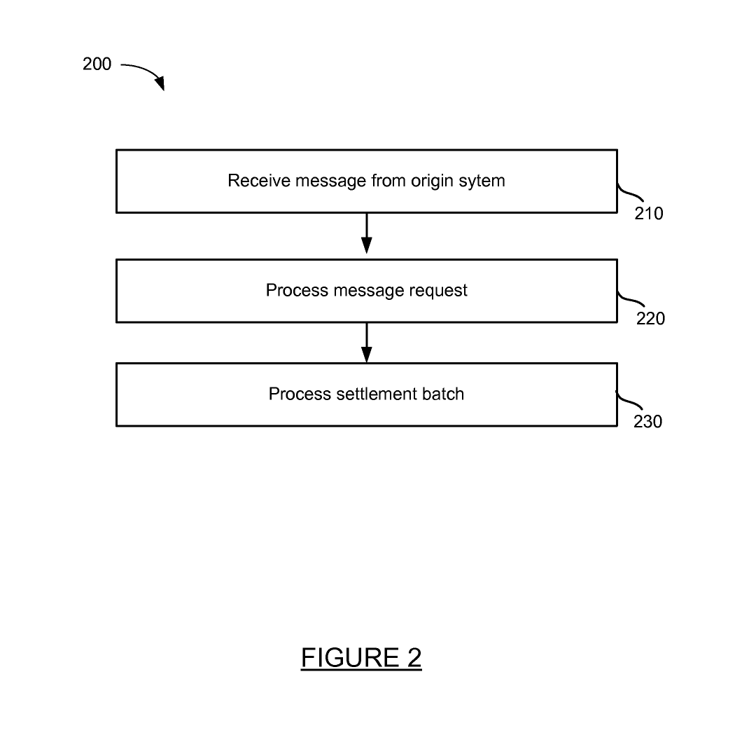

FIG. 2 illustrates a method for processing messages. The method of FIG. 2 may be performed by application server 140. First, a message is received from an origin system at step 210. The message may be a credit card authorization request, a room reservation for a casino, hotel or other establishment associated with a destination or local system, or other message. The message may be received at a port of application server 140 allocated for the particular message format. For example, a first port at application server 140 may receive all messages in Opera format and a second port may receive all messages in Micros 9700 format.

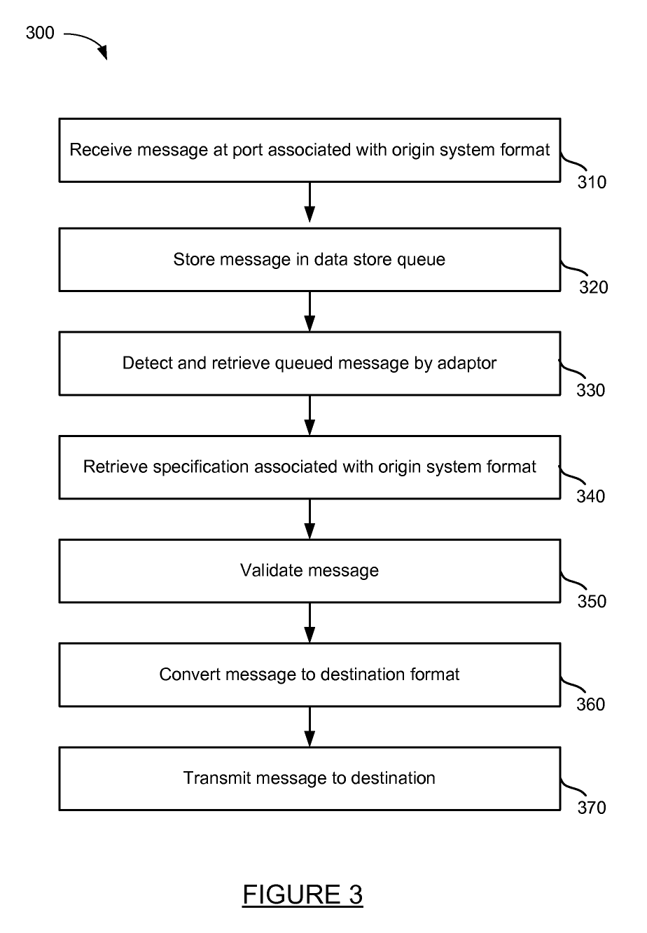

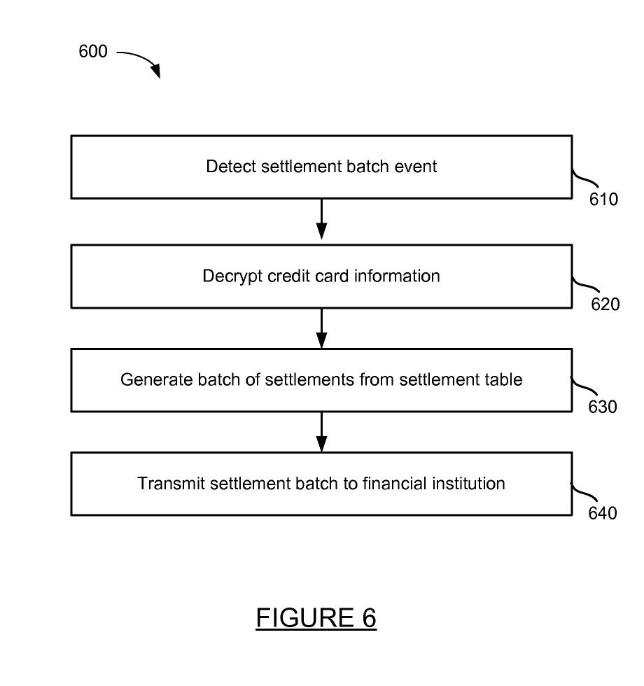

The received message may be processed at step 220. Processing the received message may include processing a credit authorization request, a credit settlement request, a reservation, or other event. In some instances, processing a message may include translating the message from the origin format to a destination format. More detail for processing a message request by translating the message format is discussed with respect to the method of FIG. 3. More detail for processing a settlement request is discussed with respect to the method of FIG. 6. More detail for processing an batch settlement is discussed with respect to the method of FIG. 6.

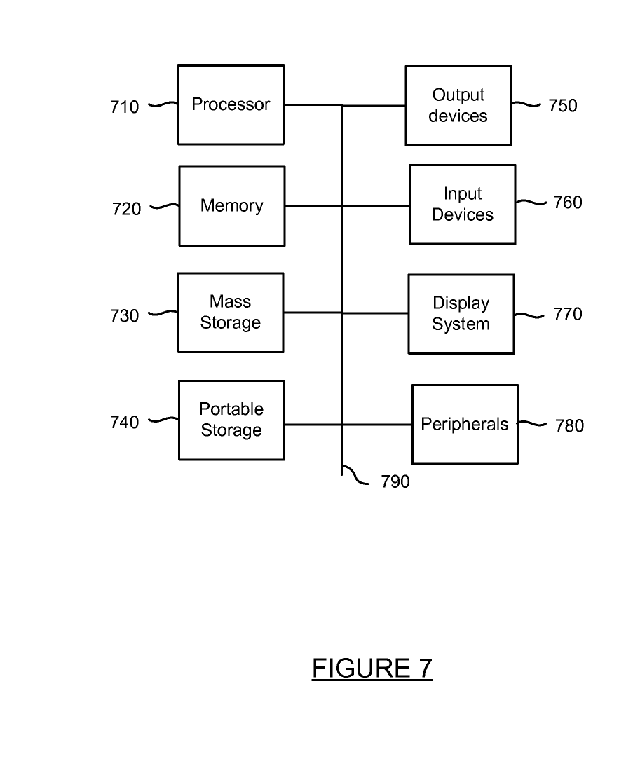

Periodically, settlements for one or more credit cards may be processed by casinos and other systems. To be more efficient, the settlement requests may be processed in batches. At step 230, a batch of settlement requests may be processed. More details for processing a batch of settlement requests is discussed with respect to the method of FIG. 7.

FIG. 3 illustrates a method for processing a message request. The method of FIG. 3 may provide more information for step 220 of the method of FIG. 2.

A message may be received at a port associated with an origin system format at step 310. The message may be a credit card authorization request or settlement request, a reservation request, or other message. The message may be received at a port designated for the particular type of message. For example, a first port may be configured to accept OPERA type messages while a second port may be configured to accept Micros 9700 type messages.

Messages received at step 320 may be stored in a queue. The queue may be maintained in data store 150. In some embodiments, the messages may be processed in the order they are entered into the queue. In some embodiments, the messages may be weighted such that messages of a particular type or from a particular origin may be weighted differently from other messages (i.e., may be moved towards the front of the queue).

An adaptor may detect and receive a message from the queue at step 330. When an adaptor is available, the adaptor may access a queued message. In some embodiments, one or more executable applications or components may monitor the queue and provide the message at the front of the queue to an available adaptor.

A specification associated with the origin system may be retrieved at step 340. The specification may be retrieved by the adaptor, which may detect the origin of the message from information in the message header, body, or other portions of the message.

The message may be validated using the specification at step 350. Validation may include confirming if the message is from a legitimate source, such as a casino, hotel, or other service industry business rather than an entity that is unauthorized to conduct transactions with or through the business operating application server 140. If the message is validated to be from a legitimate source the method continues to step 360. If the message is not validated, the method of FIG. 3 ends. In some instances, after validating a message, the present technology may apply business logic, encrypt the card information and store the encrypted card information in the database.

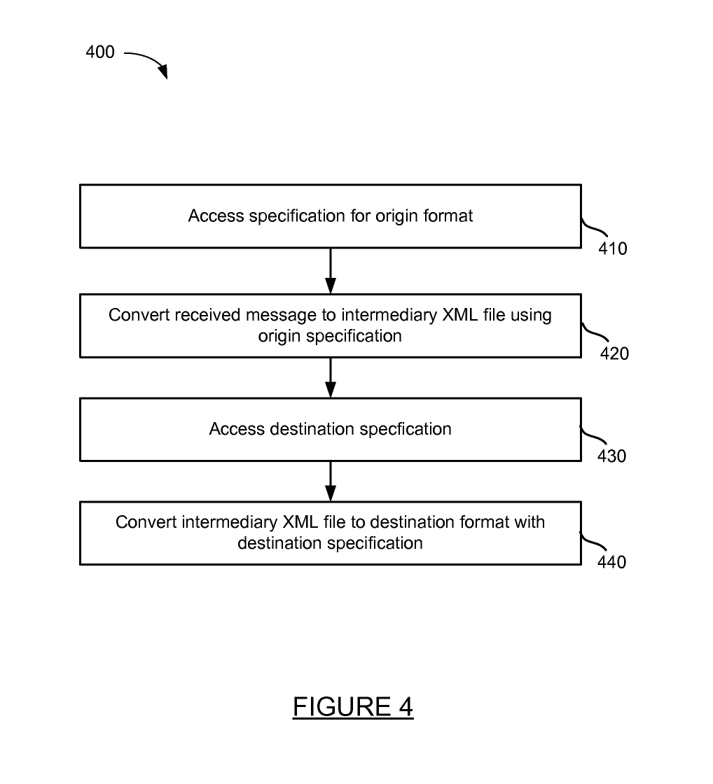

The message is converted to a destination format at step 360. Converting the message may include converting the message to an intermediary format using the accessed specification and then to a destination format using a specification associated with the destination. Converting a received message to a destination format is discussed in more detail below with respect to the method of FIG. 4. Once the message is converted to a format compatible with its intended destination, the message is transmitted to its destination at step 370.

FIG. 4 illustrates a method for converting a message to a destination format. The method of FIG. 4 may provide more detail for step 360 of the method of FIG. 3. A specification 152 associated with the origin format may be accessed 410. The specification 152 may be accessed by an adaptor and may include the same specification retrieved at step 340 in the method of FIG. 3. The message received at step 310 may be converted into an intermediary XML document using the specification associated with the origin at step 420. Converting the message may include taking data from the received message, including a message header, footer, body and other portions, and placing them in specific fields of the XML document. For example, message fields of business name, credit card number, expiration date, charge amount, and date may all be placed into an XML file. Not all the data in the message may be transferred, and one or more fields in the XML file may not be filled (i.e., may be empty) after transferring the data from the received message.

The destination specification may be accessed at step 430. The destination specification specifies how to construct a message to be sent to the destination of the original message from the origin system. The destination specification may indicate what fields of the XML file should be included in the message, where the data of the XML file should be included, and other data for constructing the message to the destination system. The intermediary XML file is converted to the destination format with the destination specification at step 440. Converting the message may include taking data from the XML document and placing the data in the message, including message header, footer and body. Not all the data in the XML file may be transferred to the destination message, depending on the format and requirements of the destination system.

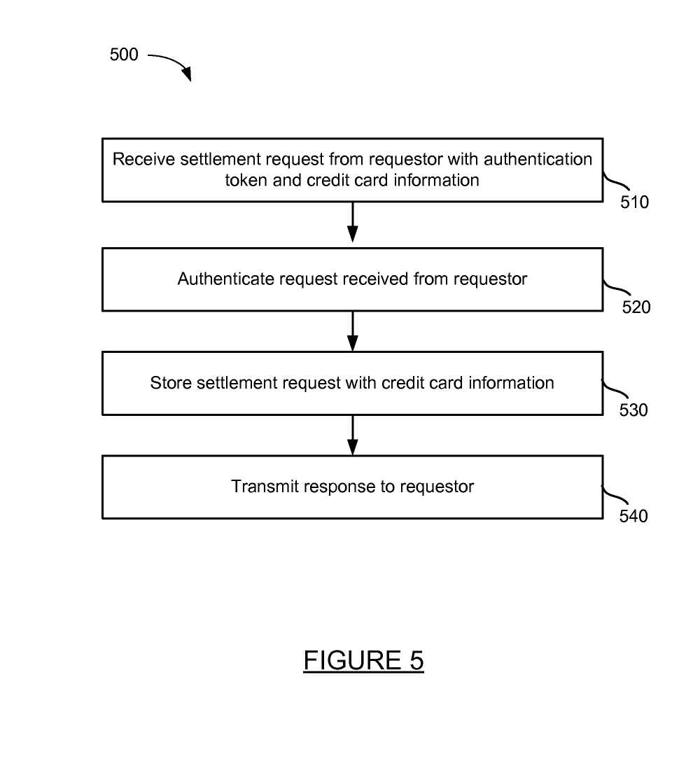

FIG. 5 illustrates a method for processing an settlement request. A settlement request is received at step 510. The settlement request may include an authentication token and credit card information. In some embodiments, the credit card information may be sent over an encrypted protocol and/or may be encrypted itself. The settlement request may be authenticated at step 520. The request may be authenticated based on an IP address of the requestor, a code or other information included in the request header or other portion of the request, or in some other manner.

The settlement request may be stored at step 530. The settlement request may be stored in table of settlement request along with the encrypted credit card data and an index. The index may be generated by hashing the credit card number or some other index generation technique. A response to the settlement request is generated and transmitted to the requestor at step 540. The response may confirm the request receipt as well the status of the request.

FIG. 6 illustrates a method for processing a settlement batch. First, a settlement batch event is detected at step 610. The event may be associated with a trigger that occurs on a daily basis, an event such as the accumulation of a certain number of settlements, a request from a financial institution, a user request to send the settlements, or some other event. Upon detecting a settlement batch event, credit card information is decrypted along with other information from the settlement table at step 620.

A batch of settlements is created from the decrypted credit cards and other settlement information at step 630. The generated batch is then transmitted to financial institution 190 from the application server 140 at step 640. The financial institution 190 may send a response to the application server to confirm that the batch was received. The batch may be sent in any number of protocols per the financial institution interface, such as for example using FTP protocol.

FIG. 7 is a block diagram of an exemplary computing system for implementing the present technology. System 700 of FIG. 7 may be implemented for computing devices such as the contexts of the likes of OPERA-based system 110, third party system 120, third party system 130, application server 140, local system 160, third party destination system 170, third party destination system 180, and financial institution 190. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for processing a message intended for a destination, comprising:
receiving by an application at a server a first message from a first system associated with a first hospitality business of a plurality of systems and intended for a second system associated with a second hospitality business, the message having a first format associated with the first system;
detecting the intended destination of the first message in the file without sending a message to the destination, the intended destination determined from the first message and transferred to the file from the first message;
accessing a specification associated with the detected destination;
converting at the server the first message into a file having a second format, the conversion of the first message performed using a first specification associated with the first system;
generating a second message having a third format associated with the second system from the file, the second message generated using a third specification associated with the second system, the third specification including the specification with the detected destination;
receiving at the server a third message by an application from a third system associated with a third hospitality business of the plurality of systems and intended for fourth system associated with a fourth hospitality business, the third message having a format associated with the third system;
converting at the server the third message into a second file having the second format, the conversion of the third message performed using a second specification associated with the third system;
generating at the server a forth message having a format associated with the fourth system from the second file, the fourth message generated using a fourth specification associated with the fourth system;
transmitting the second message to the second system by the server; and
transmitting the fourth message to the fourth system by the server.

2. The method of claim 1, wherein the first format of the first message is not compatible with the third format associated with the second system.

3. The method of claim 1, wherein the first message is converted into the file using a specification associated with the first system.

4. The method of claim 3, wherein the specification includes a mapping between portions of the first message and portions of the first file.

5. The method of claim 3, wherein the specification is accessed locally by the application.

6. The method of claim 1, further comprising retrieving a first specification of a plurality of specifications, the first specification including mapping information for adding information from the first message to the file.

7. The method of claim 1, wherein the second message is generated from the file using a specification associated with the second system.

8. The method of claim 7, wherein the specification includes a mapping between portions of the file and the second message.

9. The method of claim 1, further comprising:
placing the first message in a queue, the queue containing a plurality of messages to be sent to a plurality of destinations.

10. (canceled)

11. A non-transitory computer readable storage medium having embodied thereon a program, the program being executable by a processor to perform a method for processing a message intended for a destination, the method comprising:
receiving by an application at a server a first message from a first system associated with a first hospitality business of a plurality of systems and intended for a second system associated with a second hospitality business, the message having a first format associated with the first system;
detecting the intended destination of the first message in the file without sending a message to the destination, the intended destination determined from the first message and transferred to the file from the first message;
accessing a specification associated with the detected destination;
converting at the server the first message into a file having a second format, the conversion of the first message performed using a first specification associated with the first system;
generating a second message having a third format associated with the second system from the file, the second message generated using a third specification associated with the second system, the third specification including the specification with the detected destination;
receiving a third message by an application from a third system associated with a third hospitality business of the plurality of systems and intended for fourth system associated with a fourth hospitality business, the third message having a format associated with the third system;
converting the third message into a second file having the second format, the conversion of the third message performed using a second specification associated with the third system;
generating a forth message having a format associated with the fourth system from the second file, the fourth message generated using a fourth specification associated with the fourth system;
transmitting the second message to the second system; and
transmitting the fourth message to the fourth system.

12. The non-transitory computer readable storage medium of claim 11, wherein the first format of the first message is not compatible with the third format associated with the second system.

13. The non-transitory computer readable storage medium of claim 11, wherein the first message is converted into the file using a specification associated with the first system.

14. The non-transitory computer readable storage medium of claim 13, wherein the specification includes a mapping between portions of the first message and portions of the first file.

15. The non-transitory computer readable storage medium of claim 13, wherein the specification is accessed locally by the application.

16. The non-transitory computer readable storage medium of claim 11, the method further comprising retrieving a first specification of a plurality of specifications, the first specification including mapping information for adding information from the first message to the file.

17. The non-transitory computer readable storage medium of claim 11, wherein the second message is generated from the file using a specification associated with the second system.

18. The non-transitory computer readable storage medium of claim 17, wherein the specification includes a mapping between portions of the file and the second message.

19. The non-transitory computer readable storage medium of claim 11, the method further comprising:
placing the first message in a queue, the queue containing a plurality of messages to be sent to a plurality of destinations.

20. A system for encrypting data, comprising:
a processor;
memory; and
one or more software modules stored in the memory and executed by the processor to receive a first message by an application from a first system associated with a first hospitality business of a plurality of systems and intended for a second system associated with a second hospitality business, the message having a first format associated with the first system, detect the intended destination of the first message in the file without sending a message to the destination, the intended destination determined from the first message and transferred to the file from the first message, access a specification associated with the detected destination, convert the first message into a file having a second format, the conversion of the first message performed using a first specification associated with the first system, generate a second message having a third format associated with the second system from the file, the third specification including the specification with the detected destination, the second message generated using a third specification associated with the second system, receive a third message by an application from a third system associated with a third hospitality business of the plurality of systems and intended for fourth system associated with a fourth hospitality business, the third message having a format associated with the third system, convert the third message into a second file having the second format, the conversion of the third message performed using a second specification associated with the third system, generate a forth message having a format associated with the fourth system from the second file, the fourth message generated using a fourth specification associated with the fourth system, transmit the second message to the second system; and transmit the fourth message to the fourth system.
